(19) United States
(12) Patent Application Publication
(10) Pub. No.: US 2006/0085985 A1
(43) Pub. Date: Apr. 27, 2006

(54) Reciprocating type head-moving razor

(76) Inventor: Tae-Jun Oh, Namyangju-shi (KR)

Correspondence Address: CANTOR COLBURN, LLP, 55 GRIFFIN ROAD SOUTH, BLOOMFIELD, CT, 06002, US

(21) Appl. No.: 11/248,529

(22) Filed: Oct. 12, 2005

(30) Foreign Application Priority Data
Oct. 12, 2004 (KR) 20-2004-0028807

(51) Int. Cl. B26B 19/02; B26B 21/52

(52) U.S. Cl. 30/43.92; 30/527

(57) ABSTRACT

Disclosed herein is a reciprocating type head-moving razor including a head part having a drive motor and a double cutting blade. The head part is movable relative to a body part. The body part has an upper end disposed below the lower surface of the head part. The head part is provided at the rear surface thereof with a receiving part, in which a protrusion formed at the upper end of the body part is inserted. The body part is provided at opposite sides of the upper end thereof with supporting walls, to which opposite sides of the head part are attached, respectively, such that the head part can be moved a predetermined angular distance.

### BACKGROUND OF THE INVENTION

1. Field of the Invention

The present invention relates to a head-moving razor including a head part, which is angularly movable back and forth, and, more particularly, to a reciprocating type head-moving razor wherein cutting blades mounted in the head part are reciprocated from side to side while the head part is angularly moved back and forth.

2. Description of the Related Art

There have been proposed a large number of electric reciprocating type razors, each of which includes a plurality of cutting blade heads movable freely relative to a body part, such that the plural cutting blade heads are brought into tight contact with the skin of a user, whereby a rapid and efficient shaving operation is accomplished.

One example of the conventional electric reciprocating type razors is disclosed in Japanese Unexamined Patent Publication No. S62-227395, wherein a rotary shaft is mounted in the vicinity of the upper end of a head block including a plurality of cutting blade heads, such that the head block can be angularly moved back and forth about the rotary shaft, whereby the cutting blade heads follow the skin of a user in every shaving direction. In the disclosed electric reciprocating type razor, however, the rotary shaft is disposed in the vicinity of the upper end of the head block, and therefore, the distance between the external blades, which are brought into contact with the skin, and the rotary shaft is small. As a result, if a pressing force is small when the external cutting blades are brought into contact with the skin while being inclined to the skin, the angular movement of the head block is difficult. Furthermore, it is not possible to suspend the head blocks, i.e., it is not possible to push upward the head blocks such that the head blocks can be freely moved, and therefore, the head blocks can follow the contour of the skin only from side to side, and the head blocks cannot absorb impacts generated due to uneven bone parts when the shaving operation is performed. Consequently, the skin may be damaged, or smooth shaving operation may not be accomplished.

Another example of the conventional electric reciprocating type razors is disclosed in Japanese Unexamined Patent Publication No. S55-86490, wherein a plurality of cutting blade heads are independently suspended by means of springs, such that the cutting blade heads can be freely moved upward and downward, whereby the cutting blade heads follow the uneven skin through the vertical movement of the respective cutting blade heads while absorbing the impacts due to the unevenness of the skin. In the disclosed electric reciprocating type razor, however, it is required to set an initial load to the suspension force (the force by which the cutting blade heads are pushed upward by the respective springs) to more than a predetermined value in order to control the vibration of the entirety of the cutting blade heads due to the operation of the internal cutting blades. Consequently, if the pressing force, which is applied to the skin, is not considerably large, the cutting blade heads cannot properly follow the skin. Furthermore, when the external cutting blades are brought into contact with the skin while being inclined to the skin, the cutting blade heads cannot be brought into contact with the skin while the cutting blade heads are at a right angle to the skin. Consequently, the performance of the electric reciprocating type razor is not sufficiently accomplished.

Another example of the conventional electric reciprocating type razors is disclosed in Japanese Unexamined Patent Publication No. S63-197484, wherein a plurality of cutting blade heads are constructed to be freely moved, and adjacent cutting blade heads are coupled with each other by a ring, such that one of the coupled cutting blade heads is moved upward when the other of the coupled cutting blade heads is moved downward, whereby the cutting blade heads follow the unevenness of the skin. In the disclosed electric reciprocating type razor, however, it is not possible to absorb impacts generated when a shaving operation is performed. Furthermore, the cutting blade heads are not brought into contact with the skin while the cutting blade heads are at a right angle to the skin. Consequently, the performance of the electric reciprocating type razor is not sufficiently accomplished.

Still another example of the conventional electric reciprocating type razors is disclosed in Japanese Unexamined Patent Publication No. H10-43443, wherein cutting blade heads are integrally attached to a motor such that the cutting blade heads can be moved back and forth, from side to side, and upward and downward. In the disclosed electric reciprocating type razor, however, the supporting points provided to move the cutting blade heads are considerably low, and therefore, satisfactory following of the cutting blade heads to the skin is not accomplished.

### SUMMARY OF THE INVENTION

Therefore, the present invention has been made in view of the above problems, and it is an object of the present invention to provide a reciprocating type head-moving razor including a movable head part, the structure of which is relatively simple and which can be brought into wide and smooth contact with the skin of a user, whereby a smooth and efficient shaving operation is accomplished.

It is another object of the present invention to provide a reciprocating type head-moving razor including a plurality of cutting blade heads, which can entirely follow unevenness of the skin and which can absorb impacts generated due to uneven bone parts.

In accordance with the present invention, the above and other objects can be accomplished by the provision of a reciprocating type head-moving razor including a head part, having a drive motor and a double cutting blade, which is movable relative to a body part, wherein the body part has an upper end disposed below the lower surface of the head part, the head part is provided at the rear surface thereof with a receiving part, in which a protrusion formed at the upper end of the body part is inserted, and the body part is provided at opposite sides of the upper end thereof with supporting walls, to which opposite sides of the head part are attached, respectively, such that the head part can be moved a predetermined angular distance.

Preferably, the head part is constructed such that an insertion part is attached, at a right angle, to a drive shaft of the drive motor and an eccentric shaft formed at the upper end of the drive shaft to angularly move the cutting blade.

Preferably, the head part can be moved an angular distance of 30 degrees to 60 degrees either manually or by the operation of a rack and pinion unit, which is operated by a moving switch disposed at one side of the main body.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view schematically illustrating the external appearance of a reciprocating type head-moving razor according to the present invention;

FIG. 2 is a front view, partially in section, of the reciprocating type head-moving razor according to the present invention, schematically illustrating the structure of a head part of the reciprocating type head-moving razor;

FIG. 3 is a rear view illustrating the external appearance of the reciprocating type head-moving razor according to the present invention;

FIG. 4 is an exploded perspective view illustrating components constituting the head part of the reciprocating type head-moving razor according to the present invention;

FIG. 5 is an assembled perspective view illustrating the front structure of the head part of the reciprocating type head-moving razor according to the present invention;

FIG. 6 is an assembled perspective view illustrating the rear structure of the head part of the reciprocating type head-moving razor according to the present invention;

FIG. 7 is a side view illustrating the operation of the reciprocating type head-moving razor according to the present invention; and

FIG. 8 is a side view illustrating the structure of a rack and pinion unit applied to the reciprocating type head-moving razor according to the present invention.

### DESCRIPTION OF THE PREFERRED EMBODIMENTS

Now, a preferred embodiment of the present invention will be described in detail with reference to the accompanying drawings.

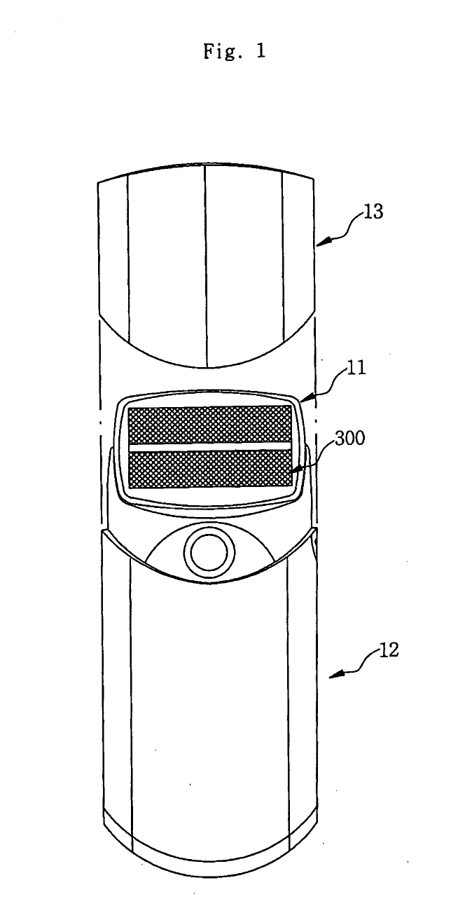

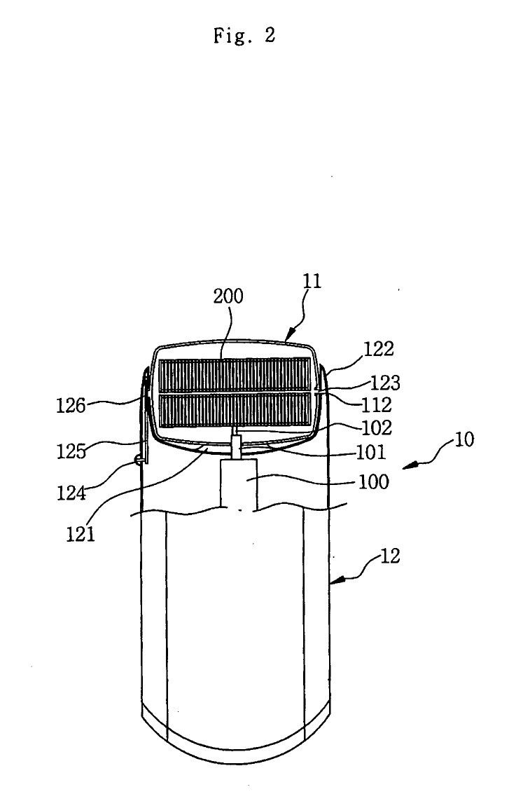

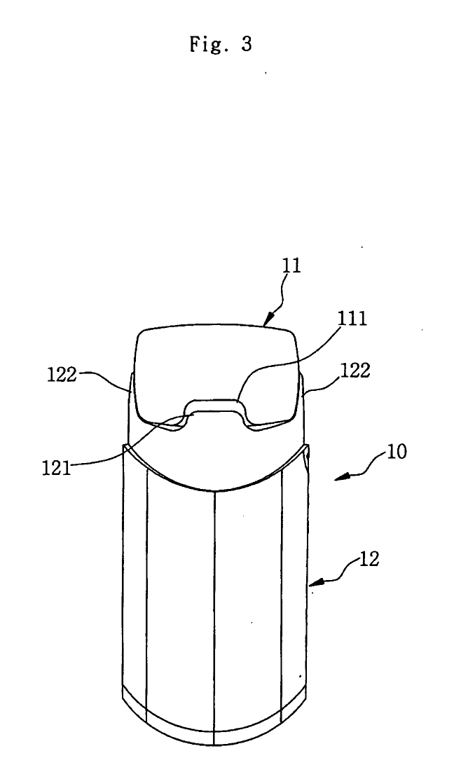

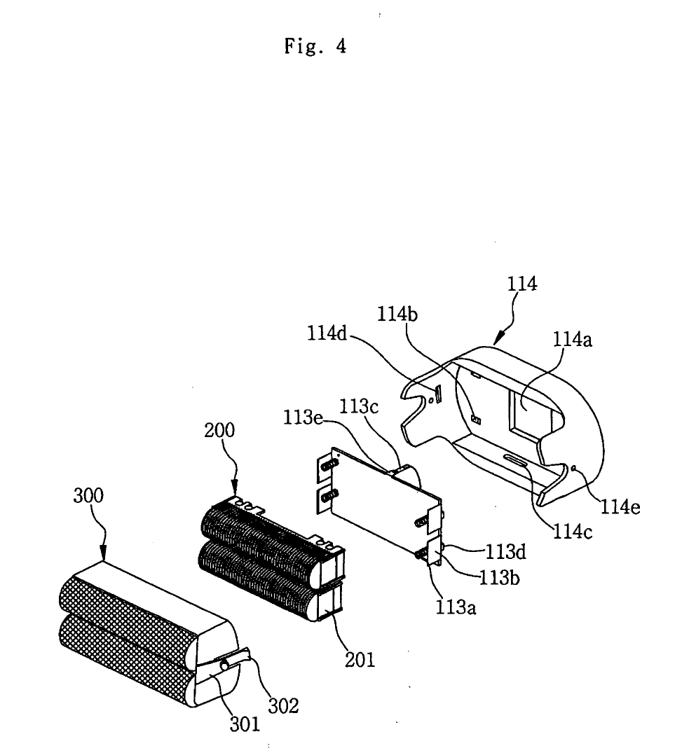

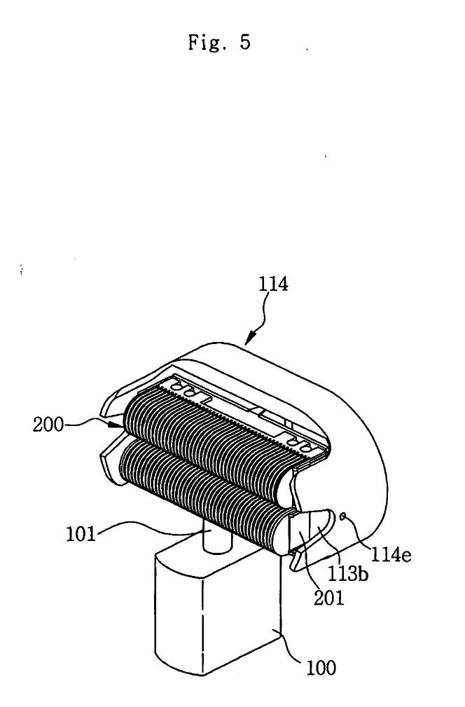

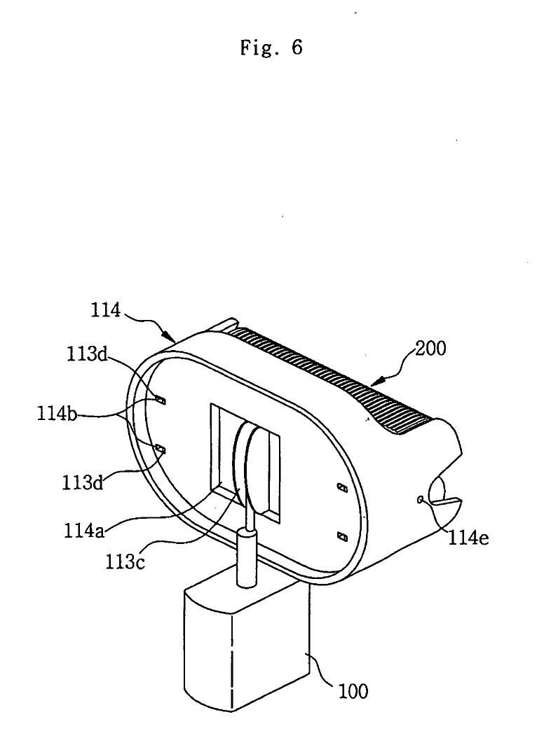

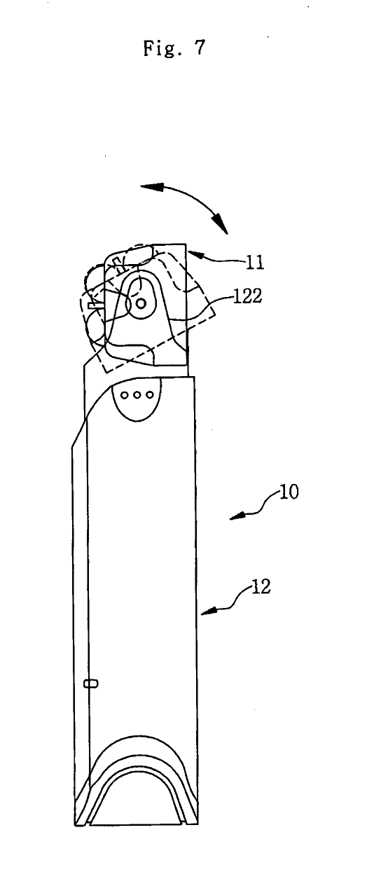

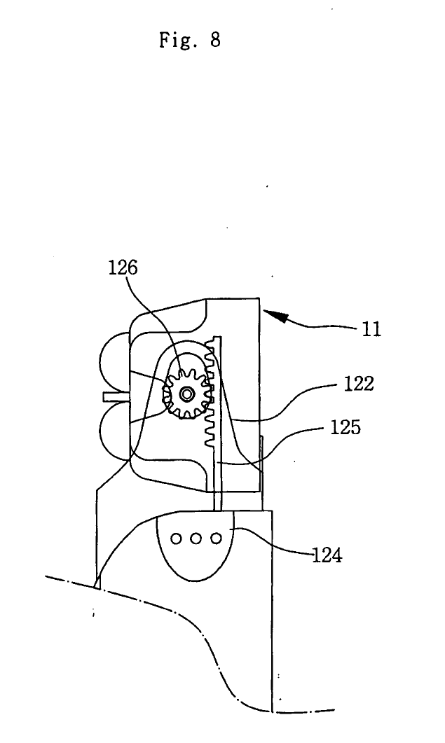

FIG. 1 is a front view schematically illustrating the external appearance of a reciprocating type head-moving razor according to the present invention, FIG. 2 is a front view, partially in section, schematically illustrating the structure of a head part of the reciprocating type head-moving razor according to the present invention, FIG. 3 is a rear view illustrating the external appearance of the reciprocating type head-moving razor according to the present invention, FIG. 4 is an exploded perspective view illustrating components constituting the head part of the reciprocating type head-moving razor according to the present invention, FIG. 5 is an assembled perspective view illustrating the front structure of the head part of the reciprocating type head-moving razor according to the present invention, FIG. 6 is an assembled perspective view illustrating the rear structure of the head part of the reciprocating type head-moving razor according to the present invention, FIG. 7 is a side view illustrating the operation of the reciprocating type head-moving razor according to the present invention, and FIG. 8 is a side view illustrating the structure of a rack and pinion unit applied to the reciprocating type head-moving razor according to the present invention.

Referring first to FIGS. 1 to 3, the reciprocating type head-moving razor according to the present invention includes a head part 11, having a drive motor 100 and a double cutting blade 200, which is movable relative to a body part 12. The upper end of the body part 12 is disposed below the lower surface of the head part 11. The head part 11 is provided at the rear surface thereof with a receiving part 111, in which a protrusion 121 formed at the upper end of the body part 12 is inserted. At opposite sides of the upper end of the body part 12 are formed supporting walls 122, to which the opposite sides of the head part 11 are attached, respectively, such that the head part 11 can be moved a predetermined angular distance.

Referring to FIG. 6, the head part 11 is constructed such that an insertion part 113c is attached, at a right angle, to a drive shaft 101 of the drive motor 100 and an eccentric shaft 102 formed at the upper end of the drive shaft 101 to angularly move the cutting blade 200.

Referring to FIGS. 2 and 8, the present invention is characterized in that the head part 11 can be moved an angular distance of 30 degrees to 60 degrees either manually or by the operation of a rack and pinion unit 125 and 126, which is operated by a moving switch 124 disposed at one side of the main body 12.

As apparent from the above description, the structure of the movable head part of the reciprocating type head-moving razor is relatively simple and can be brought into wide and smooth contact with the skin of a user. Consequently, the present invention has the effect of accomplishing a smooth and efficient shaving operation.

Furthermore, the cutting blade heads of the reciprocating type head-moving razor can entirely follow unevenness of the skin and can absorb impacts generated due to uneven bone parts.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A reciprocating type head-moving razor including a head part, having a drive motor and a double cutting blade, which is movable relative to a body part, wherein
the body part has an upper end disposed below the lower surface of the head part, the head part is provided at the rear surface thereof with a receiving part, in which a protrusion formed at the upper end of the body part is inserted, and the body part is provided at opposite sides of the upper end thereof with supporting walls, to which opposite sides of the head part are attached, respectively, such that the head part can be moved a predetermined angular distance.

2. The razor as set forth in claim 1, wherein the head part is constructed such that an insertion part is attached, at a right angle, to a drive shaft of the drive motor and an eccentric shaft formed at the upper end of the drive shaft to angularly move the cutting blade.

3. The razor as set forth in claim 1, wherein the head part can be moved an angular distance of 30 degrees to 60 degrees either manually or by the operation of a rack and pinion unit, which is operated by a moving switch disposed at one side of the main body.
